(19) United States
(12) Patent Application Publication
(10) Pub. No.: US 2007/0103410 A1
(43) Pub. Date: May 10, 2007

(54) Organic light emitting display device and driving method of the same

(76) Inventor: Choon Yul Oh, Gunpo-si (KR)

Correspondence Address: CHRISTIE, PARKER & HALE, LLP, PO BOX 7068, PASADENA, CA, 91109-7068, US

(21) Appl. No.: 11/595,092

(22) Filed: Nov. 8, 2006

(30) Foreign Application Priority Data
Nov. 9, 2005 (KR) 10-2005-0107200

(51) Int. Cl. G09G 3/30

(52) U.S. Cl. 345/77

(57) ABSTRACT

An organic light emitting display device and driving method of the same is provided. The device includes a pixel unit including pixels for receiving scan signals and emission control signals from a scan driver, and a plurality of data signals from a data driver. The device also includes a frame memory for storing input data by a frame period and transmitting the stored input data to the data driver unit. The device also includes a luminance control unit for determining the luminance of the organic light emitting display device corresponding to a total sum of the stored input data in the frame memory. The luminance control unit is adapted to: divide the input data into a plurality of regions; store the input data input into each region; and add together the input data stored in each region to calculate a total sum of the input data.

### CROSS-REFERENCE TO RELATED APPLICATIONS

This application claims priority to and the benefit of Korean Patent Application No. 10-2005-0107200, filed on Nov. 9, 2005, in the Korean Intellectual Property Office, the entire content of which is incorporated herein by reference.

### BACKGROUND

1. Field of the Invention

The present invention relates to an organic light emitting display device and a driving method of the same, and more specifically to an organic light emitting display device capable of reducing power consumption and improving image quality.

2. Discussion of Related Art

Recently, there have been developed various flat panel displays having a light weight and a small size when compared to the cathode ray tube. Special attention has been paid to organic light emitting display devices having excellent luminous efficiency, luminance, viewing angle and rapid response time.

Organic light emitting devices include a pixel unit that has a plurality of pixels configured to display a luminance of a picture.

In conventional organic light emitting display devices, a large amount of electric current flows to the pixel unit if the picture displayed in the pixel unit includes a large number of pixels displaying a high luminance. A small amount of an electric current flows to the pixel unit if the picture displayed in the pixel unit includes a large number of pixels displaying a low luminance.

To allow a large amount of electric current to flow to the pixel unit, a power supply unit coupled to the pixel unit should output high power. However, when a small amount of electric current flows to the pixel unit, the contrast of the organic light emitting display device is deteriorated due to the small difference in the luminance between the pixels displaying the brightest luminance and the pixels displaying the darkest luminance.

### SUMMARY OF THE INVENTION

In one embodiment of the invention, an organic light emitting display device is provided. The device includes a pixel unit including pixels for receiving a plurality of scan signals, a plurality of emission control signals and a plurality of data signals to display an image. The device also includes a scan driver unit for transmitting the scan signals and the emission control signals to the pixel unit; and a data driver unit for generating a plurality of data signals using input data and transmitting the data signals to the pixel unit. The device also includes a frame memory for storing the input data by a frame period and transmitting stored input data to the data driver unit; and a luminance control unit for determining a restriction width of its luminance using a total sum of the stored input data in the frame memory. The luminance control unit is adapted to: divide the input data corresponding to the frame period into a plurality of regions; store the input data input into each region; and add together the input data stored in each region to calculate a total sum of the input data.

In another embodiment of the invention, an organic light emitting display device is provided. The device includes a pixel unit including pixels for receiving a plurality of scan signals, a plurality of emission control signals and a plurality of data signals to display an image. The device also includes a scan driver unit for transmitting the scan signals and the emission control signals to the pixel unit; and a data driver unit for generating a plurality of data signals using input data and transmitting the data signals to the pixel unit. The device also includes a frame memory for storing the input data corresponding to one frame period and transmitting stored input data to the data driver unit; and a luminance control unit adapted for: limiting a luminance level of the pixel unit if a total sum of the input data stored in the frame memory is more than a predetermined value; and not limiting the luminance level of the pixel unit if the total sum of the input data stored in the frame memory is less than the predetermined value. The luminance control unit is adapted to: divide the input data into a plurality of regions; store the sum of the input data input into each region; and add together the input data stored into each region to calculate a total sum of the input data.

In the first embodiment or the second embodiment, the luminance level of the pixel unit is controlled by a width of the emission control signal. Additionally, the input data is input into at least one region out of a plurality of regions, the other regions maintain a sum of a previous input data. Further, the luminance control unit includes: a first data addition unit for dividing the input data corresponding to one frame period by region; a storage unit for dividedly storing the input data divided by region by the first data addition unit; and a second data addition unit for adding the input data dividedly stored in the storage unit to calculate a total sum of the input data input into one frame period. The luminance control unit also includes a look-up table for storing an emission information to an emission time of the pixels, which corresponds to the total sum of the input data; and a luminance control driver unit for transmitting a luminance control signal, which controls one of the plurality of emission control signals according to the emission information.

In other embodiments of either the first embodiment or the second embodiment, the luminance control unit includes a data addition unit for: receiving and adding the input data; dividing the input data by region; transmitting a sum of the input data to a storage unit; and adding the sum of the input data stored in the storage unit by region to calculate a total sum of the input data. The luminance control unit also includes a storage unit for dividing the input data corresponding to one frame period by region and dividedly storing the input data by region; a look-up table for storing an emission information to an emission time of the pixel, which corresponds to the total sum of the input data; and a luminance control driver unit for transmitting a luminance control signal, which controls one of the plurality of emission control signals according to the emission information.

In other embodiments, the storage unit includes a plurality of registers, and the plurality of the registers are adapted to maintain a sum of a previous input data before a sum of a new input data is input.

In other embodiments, the scan driver unit is adapted to receive the luminance control signal to determine a width of one of the plurality of emission control signals. The scan driver unit may be divided into: a scan driver circuit for transmitting one of the plurality of the scan signals; and an emission control driver circuit for transmitting one of the plurality of the emission control signals.

In some embodiments, a limitation of a luminance level is set to be varied according to a picture displayed in the pixel unit.

In a third embodiment of the invention, a method for driving an organic light emitting display device is provided. The method includes: dividing input data corresponding to a frame period in a plurality of regions; adding a sum of the input data in each of the plurality of regions; calculating a total sum of the input data input in one frame period; and limiting a luminance level of a pixel unit to correspond to the total sum of the input data.

In a fourth embodiment of the invention, a method for driving an organic light emitting display device is provided. The method includes: dividing input data corresponding to picture region of a pixel unit into a plurality of regions; calculating a sum of the input data input into one of the plurality of regions; calculating a sum of the input data in some of the plurality of regions in which the input data is varied; calculating a total sum of the input data input into the picture region; and limiting a luminance level of the pixel unit to correspond to the total sum of the input data.

In some embodiments of the third embodiment or the fourth embodiment, the emission time when the pixel unit emits light is determined in correspondence to the total sum of the input data.

In other embodiments of the third embodiment or the fourth embodiment, the emission the emission time when the pixel unit emits light is determined using a look-up table in which a light emitting period corresponding to the total sum of the input data is stored.

### BRIEF DESCRIPTION OF THE DRAWINGS

FIG. 1 is a schematic diagram showing a conventional organic light emitting display device.

FIG. 2 is a schematic diagram showing an organic light emitting display device according to an embodiment of the present invention.

FIG. 3 is a schematic diagram showing an embodiment of a luminance control unit used in an organic light emitting display device according to the present invention.

FIGS. 4A, 4B, 4C and 4D are diagrams showing that emission ratios of emission signals input into the organic light emitting display device according to the present invention is limited to at most 33%.

FIGS. 5A, 5B, 5C and 5D are diagrams showing that emission ratios of emission signals input into the organic light emitting display device according to the present invention is limited to at most 50%.

### DETAILED DESCRIPTION

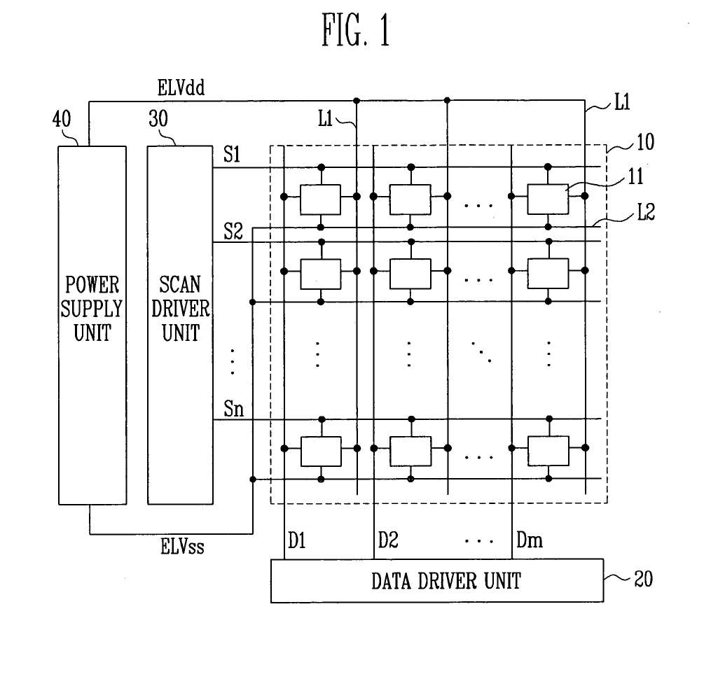

Referring to FIG. 1, a conventional organic light emitting display device includes a pixel unit 10, a data driver unit 20, a scan driver unit 30 and a power supply unit 40.

A plurality of pixels 11 are arranged in the pixel unit 10, and a light emitting device (not shown) is coupled to each pixel 11. The n scan lines S1,S2, . . . Sn-1,Sn are formed in a transversal direction and transmit a scan signal. The m data lines D1, D2, . . . Dm-1, Dm are formed in a longitudinal direction and transmit a data signal. The m first power supply lines (not shown) transmit power of the first power supply. The m second power supply lines (not shown) transmit voltage ELVss of the second power supply, wherein the ELVss has a lower potential than the voltage ELVdd of the first power supply. The pixel unit 10 displays an image by allowing the light emitting device to emit light using the scan signal, the data signal, the voltage ELVdd and the voltage ELVss.

The data driver unit 20 is adapted for applying the data signal to the pixel unit 10. The data driver unit 20 is coupled with the data lines D1, D2, . . . Dm-1, Dm of the pixel unit 10 to apply the data signal to the pixel unit 10.

The scan driver unit 30 is adapted for sequentially outputting the scan signal. The scan driver unit 30 is coupled with the scan lines S1,S2, . . . Sn-1,Sn to transmit the scan signal to a specific row of the pixel unit 10. The data signal in the data driver unit 20 is applied to the specific row of the pixel unit 10 to which the scan signal is transmitted thereby displaying an image. One frame is completed if all rows are sequentially selected.

The power supply unit 40 transmits voltage ELVdd and voltage ELVss to the pixel unit 10 to allow an electric current, corresponding to the data signal, to flow in each pixel 11. Such is due to the voltage difference between the voltage ELVdd and the voltage ELVss. The voltage difference results because the voltage ELVss has a lower potential than the voltage ELVdd.

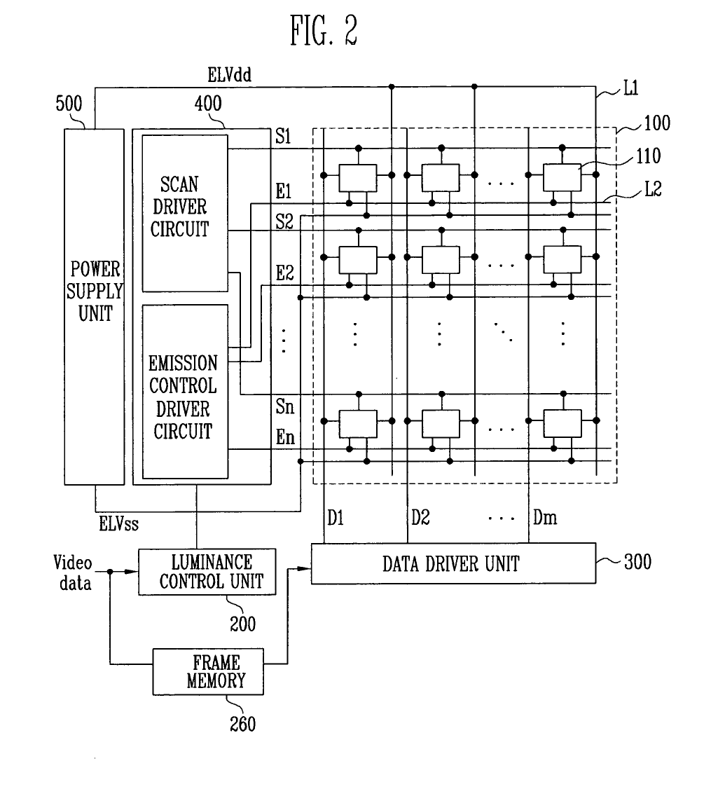

FIG. 2 is a schematic diagram showing an organic light emitting display device according to an embodiment of the present invention. The organic light emitting display device includes a pixel unit 100, a luminance control unit 200, a frame memory 260, a data driver unit 300, a scan driver unit 400 and a power supply unit 500.

A plurality of pixels 110 are arranged in the pixel unit 100, and a light emitting device (not shown) is coupled to each pixel 110. The n scan lines S1,S2, . . . Sn-1,Sn are formed in a transversal direction and transmit a scan signal. Also n emission control signal lines E1,E2, . . . En-1,En transmit an emission control signal. Further, m data lines D1, D2, . . . Dm-1, Dm are formed in a longitudinal direction and transmit a data signal. A first power supply line L1 transmits voltage ELVdd to the pixel 110. A second power supply line L2 transmits voltage ELVss to the pixel. The second power supply line L2 may be formed in a front region of the pixel unit 100 to be electrically coupled to each pixel 110.

The luminance control unit 200 limits the luminance level to correspond to the sum of the input data (e.g., video data) into the pixel unit 100 during one frame period. The luminance control unit 200 outputs a luminance control signal to display a picture. When the amount of input data is large, a larger amount of electric current flows in the pixel unit 100 than when the amount of the input data is small. Accordingly, if a larger amount of electric current flows, then the luminance is reduced and the corresponding image is displayed by limiting the electric current.

The luminance control unit 200 calculates the total sum of the input data that is input into one frame, and then estimates that an amount of the current flowing to the pixel unit 100 is larger if the amount of the input data is large, while a current amount flowing to the pixel unit 100 is smaller if the amount of the input data is small. Accordingly, the luminance control unit 200 outputs a luminance control signal for limiting the luminance level if the total sum of the input data is more than a predetermined value. The luminance control unit 200 thereby reduces and controls the brightness of the image displayed in the pixel unit 100.

If the luminance of the pixel unit 100 is limited by the luminance control unit 200, then a high power supply unit 500 may not be required since the current amount flowing to the pixel unit 100 is limited. And, if the luminance of the pixel unit 100 is not limited, then an emission time of the light-emitted pixel may be maintained for a long time to enhance the luminance. Accordingly, the contrast ratio between the pixels that are emitting light and the pixels that are not emitting light is increased. Accordingly, if the luminance of the pixel unit 100 is presented with a low gray level, then the contrast ratio of the pixel unit 100 is improved since the restriction width of the luminance is small and its luminance is not limited.

If an emission time of the pixel is reduced as the method for reducing the current amount flowing to the pixel unit 100, then the time when the electric current is supplied may be shortened, which may reduce the current amount flowing to the pixel unit 100.

In order to control the time when the pixel unit 100 emits light, the luminance control unit 200 controls a pulse width of the emission control signal, which is transmitted through the emission control signal lines E1,E2, . . . En-1,En. The emission control signal controls an emission time when pixel unit 100 emits the light in one frame. The entire luminance of the pixel unit 100 may not be reduced by increasing the current amount input into the pixel unit 100 if it has a long pulse width. The entire luminance of the pixel unit may be reduced by reducing the current amount input into the pixel unit 100 if it has a short pulse width.

The frame memory 260 receives input data and stores the input data corresponding to one frame period. The frame memory 260 transmits the input data to the data driver unit by frame. The amount of the input data stored in the frame memory 260 corresponds to the number of the pixels included in the pixel unit 100. The amount of input data transmitted to the frame memory 260 may be as much as the number of the pixels or an amount less than the number of the pixels. A displayed picture is changed into a new picture different from the prior picture or different input data is included in a large amount when compared to the prior picture if the amount of the input data transmitted is as much as the number of pixels. A displayed picture is changed at a smaller amount when compared to the prior picture or the prior frame is maintained if the amount of the input data transmitted is not as much as the number of pixels. And, if the frame memory 260 transmits the input data that is a smaller amount than the number of pixels, then the changed region is changed according to the new input data, and the unchanged region maintains the prior input data. Accordingly, the frame memory 260 continues to store the same amount of input data as that of the number of pixels.

If the amount of the input data transmitted is as much as the number of pixels of the pixel unit 100, then the frame memory adds the input data transmitted to calculate the total sum of the input data, and then may determine a restriction width of its luminance using the amount of input data as a guide.

If the frame memory 260 adds transmitted input data which is in an amount smaller than that of the number of pixels of the pixel unit 100, the total sum of the input data is reduced since it adds a smaller amount of the input data than that of the input data presented in the actual picture. Therefore if a reduced total sum of the input data is used, then there is a problem that a smaller width is limited more than the width that should actually be limited.

The problem may be solved by dividing the frame memory 260 into a plurality of regions, adding a amount of a region to which the input data is changed and transmitted to store the amount, and calculating a amount of a region to which the input data is not changed and transmitted by using the prior data to obtain the total sum of the input data displayed in one picture.

The data driver unit 300 is adapted for applying a data signal to the pixel unit 100. The data driver 300 receives input data having red, blue and green color from the frame memory 260 to generate a data signal. The data driver unit 300 is coupled with data lines D1, D2, . . . Dm-1, Dm of the pixel unit 100 to apply the generated data signal to the pixel unit 100.

The scan driver unit 400 is adapted for applying a scan signal and an emission control signal to the pixel unit 100. The scan driver unit 300 is coupled with scan lines S1,S2, . . . Sn-1,Sn and emission signal lines E1,E2, . . . En-1,En to transmit the scan signal and the emission control signal, respectively, to a row of the pixel unit 100. The data signal output from the data driver unit 300 is transmitted to the pixel 110 to which the scan signal and the emission each control signal are transmitted. The emission control signal allows pixel 110 to emit light according to the emission control signal. The emission control signal is controlled by the luminance control unit 200 to control an emission time of the pixel 110.

The scan driver unit 300 may be divided into a scan drive circuit for generating a scan signal and a light emission drive circuit for generating an emission control signal. The scan drive circuit and the light emission drive circuit may be integrally included in one component or separated as separate components.

A data signal input in the data driver unit 300 is applied to the row of the pixel unit 100 to which the scan signal and the emission control signal are each transmitted, and an electric current corresponding to the emission control signal and the data signal is transmitted to the light emitting device to display an image as the organic light emitting display device is allowed to emit light. One frame is completed if all rows are sequentially selected.

The power supply unit 500 transmits voltage (ELVdd) of the first power supply and voltage (ELVss) of the second power supply to the pixel unit 100 to allow an electric current, corresponding to the data signal, to flow in each pixel by means of a difference between the voltage ELVdd the voltage ELVss. If the light is emitted with a high luminance in each pixel, then its power consumption is increased since a larger amount of the electric current flows if the light is emitted in each pixel.

FIG. 3 is a schematic diagram showing one embodiment of a luminance control unit used in an organic light emitting display device according to an embodiment of the present invention. The luminance control unit 200 includes a first data addition unit 210, a storage unit 220, a second data addition unit 230, a look-up table (LUT) 240 and a luminance control driver unit 250.

The first data addition unit 210 divides the input data that is also stored in the frame memory into a plurality of periods corresponding to a region stored in the frame memory 260. The first data addition unit 210 then adds the input data. In one embodiment, the frame memory 260 includes the addresses 1 to 1000 and is divided into four regions. The addresses 1 to 250 are represented by a first region, the addresses 251 to 500 are represented by a second region, the addresses 501 to 750 are represented by a third region, and the addresses 751 to 1,000 are represented by a fourth region. The first data addition unit 210 divides the input data stored the first region, the second region, the third region and the fourth region and adds the input data input into each region. The first data addition unit 210 adds only the input data to be stored in the first region since only the input data to be stored in the first region of the frame memory 260 is transmitted to the frame memory 260 if the input data is changed in the first region out of the four regions since the amount of the transmitted input data is smaller than the number of pixels 110 included in one picture.

The storage unit 220 includes a plurality of registers 221,222, . . . 22n. The storage unit 220 in a plurality of registers by each region stores the input data added in the first data addition unit 210. If the frame memory is divided into four regions as described above, the number of the registers is four, and the storage unit 220 stores the sum of the input data corresponding to one region in each register. If only the input data to be stored in the first region is added in the first data addition unit 210, then the sum of the input data to be stored in the first region is the sum of the input data calculated by the first data addition unit 210. Accordingly, the other registers maintain their prior input data.

The second data addition unit 230 adds the sum of each input data stored in a plurality of the registers 221,222, . . . 22n to calculate the total sum of the input data included in one frame.

It may be estimated that the data displaying a high gray level in a picture is a large amount if the total sum of the input data is large, while it may be estimated that the data displaying a high gray level in a picture is a small amount if the total sum of the input data is small.

In the LUT 240, the width of the light emitting period in the emission control signal is set according to the data value showing the total sum of the input data added by the second data addition unit 230. The width of the light emitting period is set using upper bits of the data showing the total sum of the input data. The brightness level of the pixel unit 100 may be calculated in one frame using the upper 5 bits of the total sum of the input data. In this embodiment, it is set to the upper 5 bits, but the number of the upper bit can be adjusted, in other embodiments.

The data addition unit is divided into the first data addition unit 210 and the second data addition unit 230 and described herein. In other embodiments, the first data addition unit 210 and the second data addition unit 230 may be configured as one data addition unit. The input data input into one frame period may be received from the data addition unit to add the input data by region. The added input data may be stored in each register of the storage unit 220. The data stored in each register may be received by the second data addition unit to add together the data stored in each of the registers, thereby calculating the total sum of the input data input into one frame period.

The luminance of the pixel unit 100 is gradually increased as the total sum of the input data is increased. The luminance of the pixel unit 100 is limited if the brightness is increased to at least a predetermined brightness. Also, the luminance of the pixel unit 100 is prevented from being extraordinarily increased by further increasing the ratio gradually limited as the luminance of the pixel unit 100 is increased.

If the pixel unit 100 has a ratio that evenly limits its luminance as the luminance of the pixel unit 100 is increased. A sufficiently bright picture may be not displayed and the entire brightness may be deteriorated. The brightness may be deteriorated because the luminance is excessively limited because the luminance may be limited when the pixel unit 100 displays a very high luminance. Accordingly, if the entire pixel unit 100 displays a white color by setting a range that maximally limits the luminance, a luminance limitation of the pixel unit 100 is presented from going below the limiting range by setting the limiting range.

The image displayed in the organic light emitting display device may be divided into a moving image and a still image, and its limitation range may be varied according to the kind of the image.

If the luminance is not high, then the luminance is not limited. Accordingly, the luminance is not limited when the total sum of the input data is not more than a predetermined value.

Table 1 lists an LUT 240 in which an emission ratio, namely a ratio between a predetermined period and a period. in which the luminance is emitted in one frame period is limited to 50% of the maximum value according to the luminance of the pixel unit 100. The predetermined period may be one frame period, or a shorter period than one frame period.

TABLE 1

| Upper 5 bit | Luminous | Emission | | Width of Emission |
|---|---|---|---|---|
| value | efficiency | ratio | Luminance | control signal |
| 0 | 0% | 100% | 300 | 325 |
| 1 | 4% | 100% | 300 | 325 |
| 2 | 7% | 100% | 300 | 325 |
| 3 | 11% | 100% | 300 | 325 |
| 4 | 14% | 100% | 300 | 325 |
| 5 | 18% | 100% | 300 | 325 |
| 6 | 22% | 100% | 300 | 325 |
| 7 | 25% | 100% | 300 | 325 |
| 8 | 29% | 100% | 300 | 325 |
| 9 | 33% | 100% | 300 | 325 |
| 10 | 36% | 100% | 300 | 325 |
| 11 | 40% | 99% | 297 | 322 |
| 12 | 43% | 98% | 295 | 320 |
| 13 | 47% | 96% | 287 | 311 |
| 14 | 51% | 93% | 280 | 303 |
| 15 | 54% | 89% | 268 | 290 |
| 16 | 58% | 85% | 255 | 276 |
| 17 | 61% | 81% | 242 | 262 |
| 18 | 65% | 76% | 228 | 247 |
| 19 | 69% | 72% | 217 | 235 |
| 20 | 72% | 69% | 206 | 223 |
| 21 | 76% | 65% | 196 | 212 |
| 22 | 79% | 62% | 186 | 202 |
| 23 | 83% | 60% | 179 | 194 |
| 24 | 87% | 57% | 172 | 186 |
| 25 | 90% | 55% | 165 | 179 |
| 26 | 94% | 53% | 159 | 172 |
| 27 | 98% | 51% | 152 | 165 |
| 28 | — | — | — | — |
| 29 | — | — | — | — |
| 30 | — | — | — | — |
| 31 | — | — | — | — |

Table 1 may be applied if the image is a still image. The luminance is not limited if the luminous efficiency of the pixel unit 100 is less than 36%. The ratio limiting the luminance is decreased as the luminous efficiency is decreased by limiting the luminance if the luminous efficiency exceeds 36%. In this embodiment, the luminous efficiency is a variable determined by the following Equation 1.

When the luminous efficiency is 0% it does not mean that the display device is not emitting light. Rather, it means that the upper 5 bits are 0 since the luminance of one frame is emitted at a predetermined value or less in Table 1.

$$Equation 1 \text{:} \\ Luminous Efficiency = \frac{Luminous of One Frame}{\begin{matrix}Luminous of Pixel Unit Light \text{-} Emitted \\ with Full White\end{matrix}}$$

Although most pixels of the pixel unit 100 can emit light with a maximum luminance, the ratio limiting the luminance should not be set to less than 50%. By setting the maximum limited luminous efficiency to 50%, the luminance is prevented from being excessively limited.

Table 2 lists an LUT 240 in which the maximum luminous efficiency is set to a maximum of 33% to limit the luminance to at most 33% according to the luminance of the pixel unit 100.

TABLE 2

| Upper 5 bit | Luminous | Emission | | Width of Emission |
|---|---|---|---|---|
| value | efficiency | ratio | Luminance | control signal |
| 0 | 0% | 100% | 300 | 325 |
| 1 | 4% | 100% | 300 | 325 |
| 2 | 7% | 100% | 300 | 325 |
| 3 | 11% | 100% | 300 | 325 |
| 4 | 14% | 100% | 300 | 325 |
| 5 | 18% | 99% | 298 | 322 |
| 6 | 22% | 98% | 295 | 320 |
| 7 | 25% | 95% | 285 | 309 |
| 8 | 29% | 92% | 275 | 298 |
| 9 | 33% | 88% | 263 | 284 |
| 10 | 36% | 83% | 250 | 271 |
| 11 | 40% | 79% | 237 | 257 |
| 12 | 43% | 75% | 224 | 243 |
| 13 | 47% | 70% | 209 | 226 |
| 14 | 51% | 64% | 193 | 209 |
| 15 | 54% | 61% | 182 | 197 |
| 16 | 58% | 57% | 170 | 184 |
| 17 | 61% | 53% | 160 | 173 |
| 18 | 65% | 50% | 150 | 163 |
| 19 | 69% | 48% | 143 | 155 |
| 20 | 72% | 45% | 136 | 147 |
| 21 | 76% | 43% | 130 | 141 |
| 22 | 79% | 41% | 124 | 134 |
| 23 | 83% | 40% | 119 | 128 |
| 24 | 87% | 38% | 113 | 122 |
| 25 | 90% | 36% | 109 | 118 |
| 26 | 94% | 35% | 104 | 113 |
| 27 | 98% | 34% | 101 | 109 |
| 28 | — | — | — | — |
| 29 | — | — | — | — |
| 30 | — | — | — | — |
| 31 | — | — | — | — |

Table 2 may be applied if the image is a moving image. The luminance is not limited if the luminous efficiency of the pixel unit 100 is less than 34%. The ratio limiting the luminance is increased as the luminous efficiency is increased by limiting the luminance if the luminous efficiency exceeds 34%. Although the amount of the data input into the pixel unit 100 is large, a ratio limiting the luminance should not be set to less than 33%. By setting the maximum limited luminous efficiency to 33%, the luminance is prevented from being excessively limited.

The luminance control driver unit 250 receives the upper 5 bit value of the total sum of the input data and outputs a corresponding luminance control signal. The luminance control signal is input into the scan driver unit 400. The luminance control signal controls the scan driver unit 400 to output an emission control signal according to the luminance control signal. If the scan driver unit 400 is divided into a scan driver circuit and a light emission control circuit, then the luminance control signal is input into the light emission control circuit to output an emission control signal according to the luminance control signal.

In one embodiment, the emission control signal is set to 325 for the maximum light emitting period. 8 bits may present 256 signals, 9 bits may present 512 signals, and therefore the luminance control signal may output a 9 bit signal so as to generate the light emitting period of the emission control signal as listed in Table 1. A pulse width of the start pulse input into the scan driver unit may be controlled using the luminance control signal, and the width of the emission control signal may be determined according to the varied width of the start pulse.

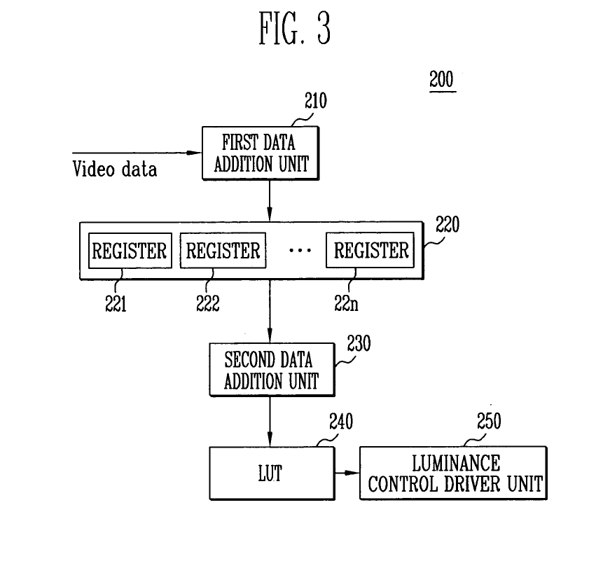

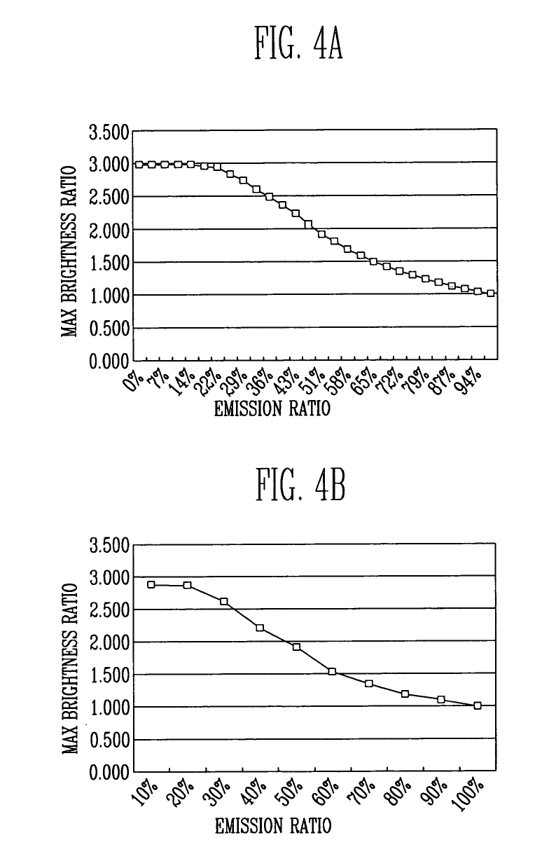

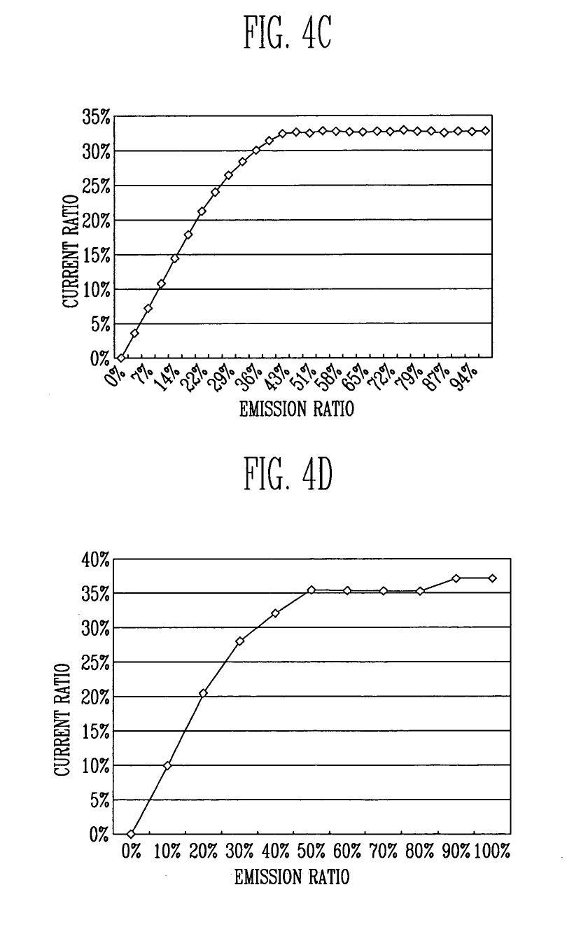

FIGS. 4A, 4B, 4C and 4D are diagrams showing that an emission ratio of an emission signal, input into the organic light emitting display device according to the present invention, is limited to at most 33%. FIG. 4A is a diagram showing a relationship between the luminous efficiency and the max brightness ratio as calculated mathematically; and FIG. 4B is a diagram showing measured values between the luminous efficiency and the max brightness (i.e., luminance) ratio. And, FIG. 4C is a diagram showing a relation between the luminous efficiency and the current ratio as calculated mathematically; and FIG. 4D is a diagram showing measured values between the luminous efficiency and the current ratio.

Referring to FIG. 4A and FIG. 4B, if the luminous efficiency is less than about 30%, then an image is not darkened since the luminance is maintained at an approximately constant level, while if the luminous efficiency exceeds about 30%, then a glaring phenomenon may be prevented since the brightness of the image is gradually reduced so that an excessively bright image cannot be displayed.

Referring to FIG. 4C and FIG. 4D, if the brightness is limited, then the power supply unit (not shown) does not need a high power. Such is the case since the electric load subject to the power supply unit may be reduced by allowing the current amount to flow by about 30 to 35% of the current amount that flows if the brightness is not limited.

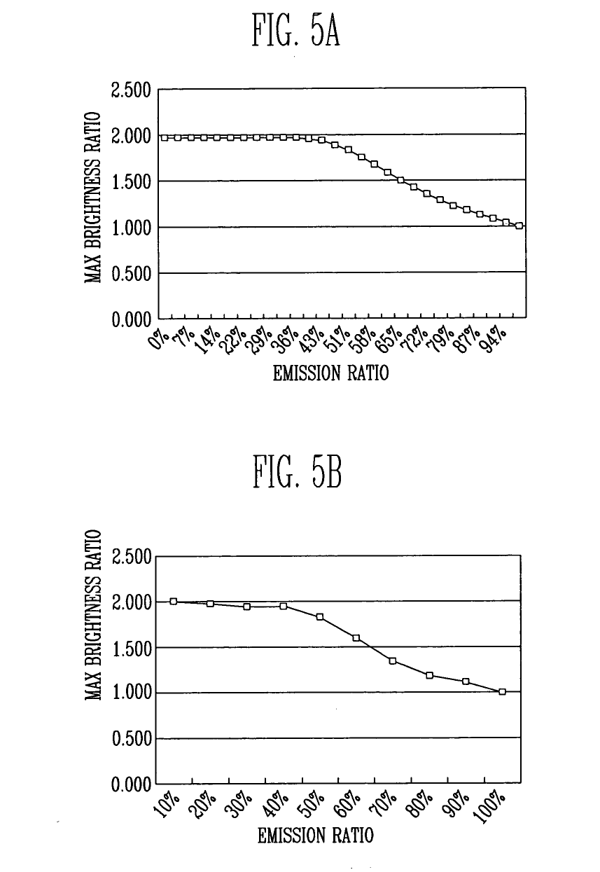

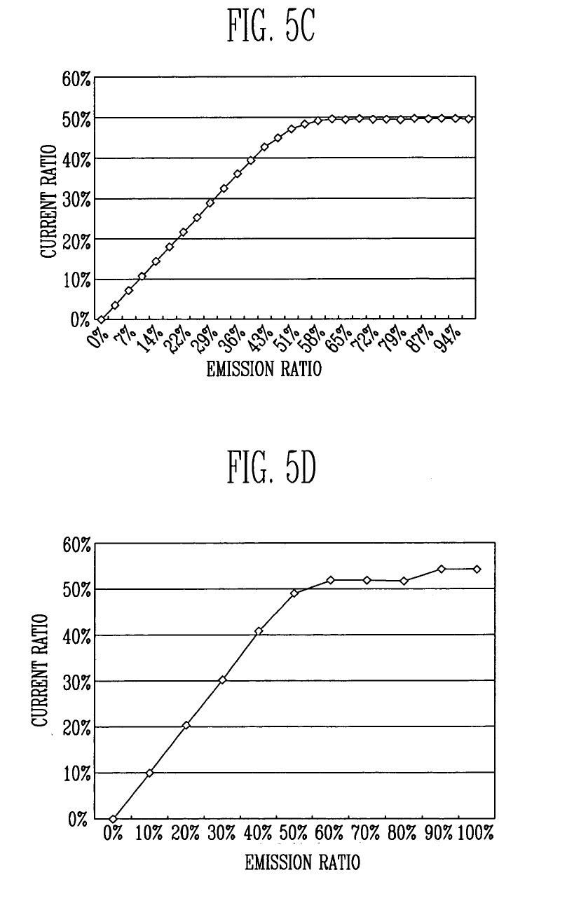

FIGS. 5A, 5B, 5C and 5D are diagrams showing that an emission ratio of an emission signal, input into the organic light emitting display device according to the present invention, is limited to at most 50%. FIG. 5A is a diagram showing a relation between the luminous efficiency and the max brightness (i.e., luminance) ratio as calculated mathematically; and FIG. 5B is a diagram showing measured values between the luminous efficiency and the max brightness ratio as calculated actually. And, FIG. 5C is a diagram showing a relation between the luminous efficiency and the current ratio as calculated mathematically; and FIG. 5D is a diagram showing measured values between the luminous efficiency and the current ratio.

Referring to FIG. 5A and FIG. 5B, if the luminous efficiency is less than about 40%, then an image is not darkened since the luminance is maintained at a constant level, while if the luminous efficiency exceeds about 40%, then a glaring phenomenon may be prevented since the brightness of the image is gradually reduced so that an excessively bright image cannot be displayed.

Referring to FIG. 5C and FIG. 5D, if the brightness is limited, then the power supply unit (not shown) does not need a high power. Such is the case since the electric load subject to the power supply unit may be reduced by allowing the current amount to flow by about 50% of the current amount that flows if the brightness is not limited.

According to the organic light emitting display device according to the present invention and a driving method of the same, its power consumption may be reduced, its image quality may be enhanced. Also, its high power supply unit may not be required because the electric current is adjusted according to the luminous efficiency of the organic light emitting display device.

Although several embodiments of the present invention have been shown and described, it would be appreciated by those skilled in the art that changes might be made in these embodiments without departing from the principles and spirit of the invention, the scope of which is defined in the claims and their equivalents.

What is claimed is:

1. An organic light emitting display device comprising:
a pixel unit including pixels for receiving a plurality of scan signals, a plurality of emission control signals and a plurality of data signals to display an image;
a scan driver unit for transmitting the scan signals and the emission control signals to the pixel unit;
a data driver unit for generating a plurality of data signals using input data and transmitting the data signals to the pixel unit;
a frame memory for storing the input data by a frame period and transmitting stored input data to the data driver unit; and
a luminance control unit for determining a restriction width corresponding to luminance of the organic light emitting display device using a total sum of the stored input data in the frame memory, wherein the luminance control unit is adapted to:
divide the input data corresponding to the frame period into a plurality of regions;
store the input data input into each region; and
add together the input data stored in each region to calculate a total sum of the input data.

2. An organic light emitting display device comprising:
a pixel unit including pixels for receiving a plurality of scan signals, a plurality of emission control signals and a plurality of data signals to display an image;
a scan driver unit for transmitting the scan signals and the emission control signals to the pixel unit;
a data driver unit for generating a plurality of data signals using input data and transmitting the data signals to the pixel unit;
a frame memory for storing the input data corresponding to one frame period and transmitting stored input data to the data driver unit; and
a luminance control unit adapted for:
limiting a luminance level of the pixel unit if a total sum of the input data stored in the frame memory is more than a predetermined value; and
not limiting the luminance level of the pixel unit if the total sum of the input data stored in the frame memory is less than the predetermined value,
wherein the luminance control unit is adapted to:
divide the input data into a plurality of regions;
store the sum of the input data input into each region; and
add together the input data stored into each region to calculate a total sum of the input data.

3. The organic light emitting display device of claim 1, wherein the luminance level of the pixel unit is controlled by a width of the emission control signal.

4. The organic light emitting display device of claim 1, wherein if the input data is input into at least one region out of a plurality of regions, the other regions maintain a sum of a previous input data.

5. The organic light emitting display device of claim 1, wherein the luminance control unit comprises:
a first data addition unit for dividing the input data corresponding to one frame period by region;
a storage unit for dividedly storing the input data divided by region by the first data addition unit;
a second data addition unit for adding the input data dividedly stored in the storage unit to calculate a total sum of the input data input into one frame period;
a look-up table for storing an emission information to an emission time of the pixels, which corresponds to the total sum of the input data; and
a luminance control driver unit for transmitting a luminance control signal, which controls one of the plurality of emission control signals according to the emission information.

6. The organic light emitting display device according to claim 1, wherein the luminance control unit comprises:
a data addition unit for:
receiving and adding the input data;
dividing the input data by region;
transmitting a sum of the input data to a storage unit; and
adding the sum of the input data stored in the storage unit by region to calculate a total sum of the input data;
a storage unit for dividing the input data corresponding to one frame period by region and dividedly storing the input data by region;
a look-up table for storing an emission information to an emission time of the pixel, which corresponds to the total sum of the input data; and
a luminance control driver unit for transmitting a luminance control signal, which controls one of the plurality of emission control signals according to the emission information.

7. The organic light emitting display device of claim 5, wherein the storage unit includes a plurality of registers, and the plurality of the registers are adapted to maintain a sum of a previous input data before a sum of a new input data is input.

8. The organic light emitting display device of claim 5, wherein the scan driver unit is adapted to receive the luminance control signal to determine a width of one of the plurality of emission control signals.

9. The organic light emitting display device of claim 6, wherein the scan driver unit is divided into:
a scan driver circuit for transmitting one of the plurality of the scan signals; and
an emission control driver circuit for transmitting one of the plurality of the emission control signals.

10. The organic light emitting display device of claim 1, wherein a limitation of a luminance level is set to be varied according to a picture displayed in the pixel unit.

11. A method for driving an organic light emitting display device, the method comprising:
dividing input data corresponding to a frame period in a plurality of regions;
adding a sum of the input data in each of the plurality of regions;
calculating a total sum of the input data input in one frame period; and
limiting a luminance level of a pixel unit to correspond to the total sum of the input data.

12. A method for driving an organic light emitting display-device, the method comprising:
dividing input data corresponding to picture region of a pixel unit into a plurality of regions;
calculating a sum of the input data input into one of the plurality of regions;
calculating a sum of the input data in some of the plurality of regions in which the input data is varied;
calculating a total sum of the input data input into the picture region; and
limiting a luminance level of the pixel unit to correspond to the total sum of the input data.

13. The method for driving an organic light emitting display device of claim 11, wherein an emission time when the pixel unit emits light is determined in correspondence to the total sum of the input data.

14. The method for driving an organic light emitting display device of claim 11, wherein an emission time when the pixel unit emits light is determined using a look-up table in which a light emitting period corresponding to the total sum of the input data is stored.
